(19) United States
(12) Patent Application Publication
(10) Pub. No.: US 2019/0022595 A1
(43) Pub. Date: Jan. 24, 2019

(54) A METHOD OF FORMING A THIN FILM THROUGH-HOLE MEMBRANE

(71) Applicants: Singapore University of Technology and Design, Singapore (SG); National University of Singapore, Singapore (SG)

(72) Inventors: Him Cheng Wong, Singapore (SG); Hong Yee Low, Singapore (SG); Virgile Viasnoff, Singapore (SG)

(21) Appl. No.: 16/068,473

(22) PCT Filed: Jan. 9, 2017
(86) PCT No.: PCT/SG2017/050010

§ 371 Date: Jul. 6, 2018

(30) Foreign Application Priority Data
Jan. 8, 2016 (SG) 10201600134R

(51) Int. Cl. B01D 67/00; B01D 71/28; B01D 71/56; B01D 71/40; B01D 69/02

(52) U.S. Cl. CPC B01D 67/0034; B01D 71/28; B01D 71/56; B01D 2325/021; B01D 67/003; B01D 69/02; B01D 2325/04; B01D 71/40

(57) ABSTRACT

There is provided a method of forming a thin film through-hole membrane comprising: providing a patterning structure, the patterning structure comprising a patterning substrate, a sacrificial layer and a thin film; imprinting the thin film with a patterned mold to form a thin-film through-hole membrane; and contacting the patterning structure with water to dissolve the sacrificial layer, thereby releasing the thin film through-hole membrane from the patterning structure. There is also provided a hierarchical membrane comprising the thin film through-hole membrane prepared from the method.

### TECHNICAL FIELD

The present invention relates to a method of forming thin film through-hole membranes.

### BACKGROUND

Through-hole membranes are extensively used in purification processes, cell biology studies and biomedical applications. Conventional polymeric membranes, fabricated by phase inversion, electrospinning, and track etching are relatively thick and have micron-sized pores with random placement and tortuous paths. On the other hand, flexible thin membranes with high porosity, small tortuosity and spatially ordered, monodisperse pores would better suit the applications' sharp size selectivity and high flux requirements but the fabrication of such membranes typically require photolithography processes; or direct writing and micromachining methods such as electron-beam lithography and focus ion beam milling which are limited by their intrinsic cost, process repetition/complexity and low throughput capability.

Examples of current methods which allow duplication of ordered surface pattern from pre-fabricated mold directly onto target material by mechanical contact and 3-D material displacement via squeeze flow and capillary action are nanoimprint lithography (NIL) and soft lithography. However, the problem with these methods is that the replica molding often leaves a thin residual layer under the mold protrusions, whose removal requires complex and laborious post fabrication processes such as reactive ion etching (RIE) and/or chemical etching, thereby leading to increased fabrication costs.

There is therefore a need for an improved method of forming thin film through-hole membranes.

### SUMMARY OF THE INVENTION

The present invention seeks to address these problems, and/or to provide an improved method of forming thin film through-hole membranes.

In general terms, the invention relates to a simple and cost-effective method which does not require any delicate laborious post-fabrication steps such as dry and/or wet etching steps in forming submicrometer thin film through-hole membranes. Further, the method also enables free. In particular, the method is based on capillary force driven mold-based lithography. The method of the present invention also allows rapid and clean transfer of the formed membrane from a patterning substrate to a target substrate.

According to a first aspect, the present invention provides a method of forming a thin film through-hole membrane comprising:
providing a patterning structure, wherein the patterning structure comprises a patterning substrate, a sacrificial layer provided on a surface of the patterning substrate and a thin film provided on the sacrificial layer, the sacrificial layer comprising a water-soluble polymer;
imprinting the thin film with a patterned mold at a pre-determined temperature for a pre-determined period of time to form the thin film through-hole membrane; and
contacting the patterning structure with water to dissolve the sacrificial layer, thereby releasing the thin film through-hole membrane from the patterning structure.

According to a particular aspect, the thin film through-hole membrane formed from the method comprises ordered and uniform-sized pores.

The thin film may comprise a thermoplastic polymer. Any suitable thermoplastic polymer may be used for the present invention. For example, the thermoplastic polymer may be selected from the group consisting of: polystyrene (PS), poly(methyl methacrylate) (PMMA), polyether block amide and combinations thereof. In particular, the thin film may comprise PS.

The sacrificial layer may comprise any suitable water-soluble polymer. According to a particular aspect, the water-soluble polymer comprised in the sacrificial layer may have a glass transition temperature higher than the pre-determined temperature. For example, the water-soluble polymer may be selected from the group consisting of: poly(sodium 4-styrenesulfonate) (PSS), acryloyl morpholine (ACMO), polyvinylpyrrolidone (PVP), and combinations thereof. In particular, the sacrificial layer may comprise PSS.

The patterned mold may comprise any suitable polymer. For example, the patterned mold may comprise an elastomeric polymer. In particular, the elastomeric polymer may be selected from the group consisting of: polydimethylsiloxane (PDMS), polyurethane acrylate (PUA), and combinations thereof. Even more in particular, the elastomeric polymer may be PDMS.

The patterning structure comprising the patterning substrate, the sacrificial layer and the thin film may be formed by any suitable method. In particular, the sacrificial layer and the thin film may be sequentially provided on the surface of the patterning substrate by spin coating, aerosol spraying, doctor blading or dip coating.

The thin film comprised in the patterning structure may have a suitable thickness. According to a particular aspect, the thickness of the thin film is less than the pillar height of the patterned mold. For example, the thin film may have a thickness of <1 μm. In particular, the thin film as provided in the patterning structure may have a thickness of 50-900 nm, 75-875 nm, 100-850 nm, 150-800 nm, 200-750 nm, 250-700 nm, 300-650 nm, 350-600 nm, 400-550 nm, 450-500 nm. Even more in particular, the thickness of the thin film may be 100-500 nm.

The sacrificial layer comprised in the patterning structure may have a suitable thickness. For example, the thickness of the sacrificial layer may be 50-200 nm. In particular, the thickness of the sacrificial layer may be 50-200 nm, 75-175 nm, 100-150 nm, 125-140 nm, 130-135 nm. Even more in particular, the thickness of the sacrificial layer may be about 150 nm.

The imprinting may be by any suitable method. For example, the imprinting may be by capillary force lithography (CFL). The imprinting may be carried out under suitable conditions such as a pre-determined temperature and pre-determined period of time. For example, the pre-determined temperature may be any suitable temperature for the purposes of the present invention. In particular, the pre-determined temperature may be a temperature which is above the glass transition temperature of the thin film.

During the imprinting, the contact angle of the thin film polymer melt on the surface of the patterned mold may be a suitable angle. In particular, the contact angle may be <90°.

According to a particular aspect, the method may further comprise treating the patterned mold with plasma prior to the imprinting. The treating may be carried out under conditions suitable for the purposes of the present invention.

The contacting may be carried out under suitable conditions. For example, the contacting may comprise contacting the patterning structure with water at room temperature.

The method may further comprise transferring the released thin film through-hole membrane onto a surface of a target substrate.

A second aspect of the present invention provides a thin film through-hole membrane prepared from the method of the first aspect.

According to a third aspect, there is provided a hierarchical membrane for graded filtration comprising at least one thin film through-hole membranes prepared from the method of the first aspect. In particular, each of the thin film through-hole membranes comprised in the hierarchical membrane comprises a different pore size. Even more in particular, the hierarchical membrane may be comprised in a membrane housing module.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1(A) shows a flow chart showing the general method of forming a thin-film through-hole membrane according to the present invention;

FIG. 1(B) shows a schematic representation of a particular embodiment of the present invention;

FIG. 2 shows a schematic representation of: (A) the patterning structure according to one embodiment of the present invention; (B) the patterning structure in contact with a patterning mold according to one embodiment of the present invention; (C) a thin film through-hole membrane on a patterning structure according to one embodiment of the present invention; and (D) a thin film through-hole membrane on a target substrate according to one embodiment of the present invention.

FIG. 3 shows a thin film through-hole membrane fabricated with a PUA patterning mold and prepared according to the method of one embodiment of the present invention;

FIG. 4 shows a hierarchical membrane according to one embodiment of the present invention;

FIG. 5 shows: a (A) microscopy image of a hierarchical membrane according to one embodiment of the present invention comprising a 25 μm membrane and a 0.35 μm membrane; and a (B) photograph of the hierarchical membrane of (A);

FIGS. 6 (a) to (d) show a custom 3-D printed membrane housing module according to one embodiment of the present invention;

FIG. 7 shows: (A) the SEM planar and perspective images of a PDMS pillar patterning mold (left) and PS thin film through-hole membrane (right), (B) SEM images of the membrane's top (left) and bottom (right) surface, (C) optical microscope image of a scratched PS membrane before (left) and after (right) removal of a PSS sacrificial layer, with the planar AFM images of the highlighted square area in the optical micrographs are shown as insets, and (D) the cross-sectional profiles of the membrane before (left) and after (right) transfer at locations indicated by the line in the inset which show easy removal of the PSS sacrificial layer and good transfer fidelity of the method of the present invention;

FIG. 8 shows (a) schematic representation of a thin film through-hole membrane according to one embodiment of the present invention being used in separation of particle, (b) an SEM image of the thin film through-hole membrane used in (a) showing larger 0.6 μm particles being fractioned from the feed while the 0.3 μm particles passing through the membrane and being present in the filtrate as verified with particle size distribution analysis using DLS and SEM as shown in (c). (d) shows schematic representation of a thin film through-hole membrane according to one embodiment of the present invention being used in another separation experiment with the SEM image shown in (e) which shows that particles are encapsulated within asymmetric pore channels after filtration, with an unoccupied pore shown in the inset. A photograph showing the feed (iii) and filtrate (iv) is shown in (f); and

FIG. 9 shows a schematic representation of an experimental setup and photographs of the various membranes used in the experiment.

### DETAILED DESCRIPTION

As explained above, there is a need for improved method of forming thin film through-hole membranes. Particulate respirator products made of charged polypropylene micro-fibres with randomly distributed inter-fibre distances generally have a wide pore size range and rough fibrous surface which leads to low nanoscale selectivity and low wettability, respectively. In addition, loose fibre compactness and tortuous pore path induced surface fouling also represent major issues which will greatly affect membrane long term performance and stability. There is therefore a need for membranes with narrow pore size distribution for optimised filtration efficiency.

The present invention provides a method of fabricating a thin film through-hole polymeric membrane with uniform and tuneable pore size down to the sub-100 nm region which is simple without involving delicate chemistries and laborious post-fabrication steps such as dry and/or wet etching. In this way, the method avoids the problems associated with etching processes. The method is also simple and scalable. Further, the membrane formed from the method may be easily detached from the substrate after patterning. Accordingly, the thin film through-hole membrane may be transferred with high fidelity onto various target substrates without defects.

According to a first aspect, there is provided a method of forming a thin film through-hole membrane comprising:
providing a patterning structure, wherein the patterning structure comprises a patterning substrate, a sacrificial layer provided on a surface of the patterning substrate and a thin film provided on the sacrificial layer, the sacrificial layer comprising a water-soluble polymer;
imprinting the thin film with a patterned mold at a pre-determined temperature for a pre-determined period of time to form the thin film through-hole membrane; and
contacting the patterning structure with water to dissolve the sacrificial layer, thereby releasing the thin film through-hole membrane from the patterning structure.

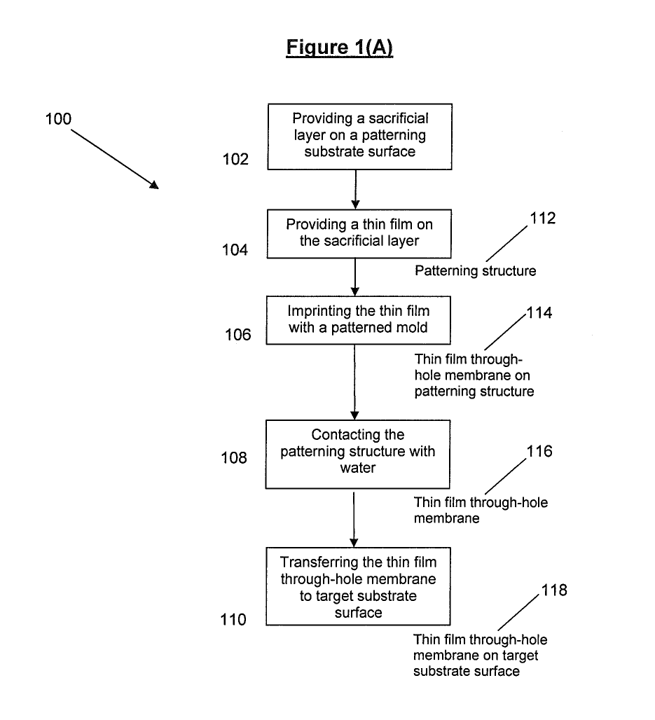

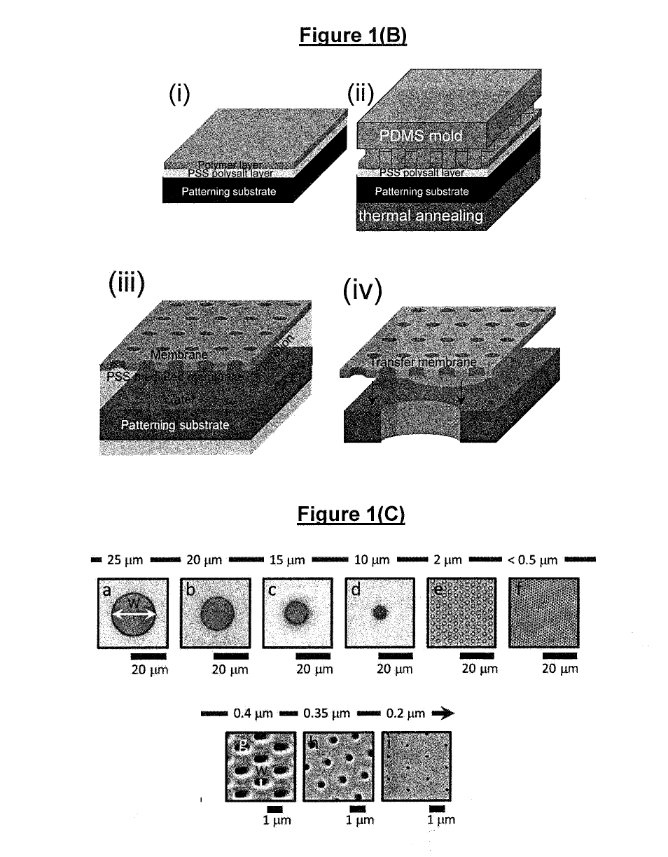

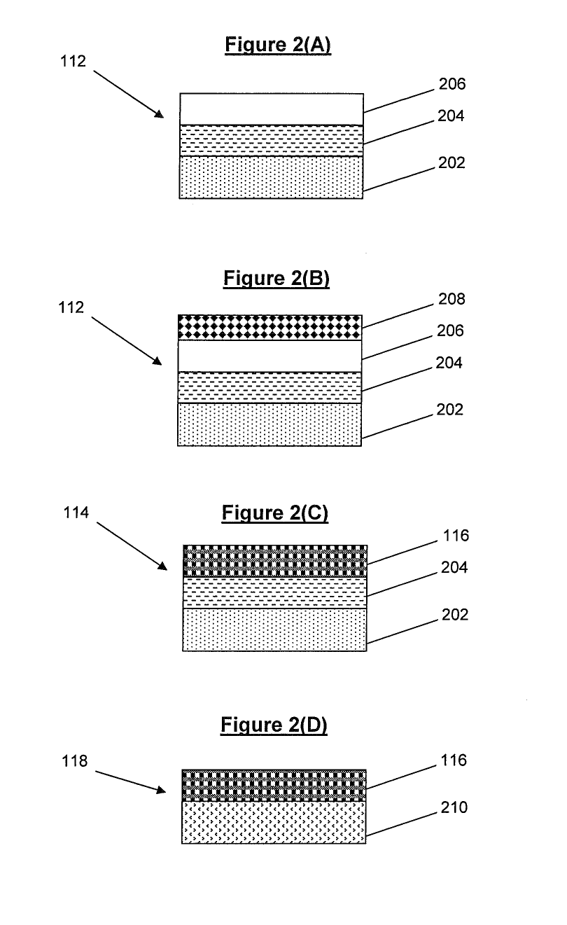

A method 100 of forming a thin film through-hole membrane and subsequently transferring the thin film through-hole membrane from one substrate to another substrate may generally comprise the steps as shown in FIG. 1(A). Reference will also be made to FIGS. 2(A) to 2(D), which exemplify a patterning structure and thin film through-hole membrane according to a particular embodiment of the present invention. Each of these steps will now be described in more detail.

Step 102 comprises providing a sacrificial layer on a patterning substrate. The sacrificial layer is a layer which may be easily provided on a surface of a substrate as well as a layer which is able to rapidly dissolve upon contacting water at room temperature instead of requiring chemical etchants. In particular, the sacrificial layer may comprise a water-soluble polymer. Any suitable water-soluble polymer may be used for providing the sacrificial layer. In particular, the water-soluble polymer comprised in the sacrificial layer may have a glass transition temperature higher than the pre-determined temperature. For example, the water-soluble polymer may be selected from the group consisting of: poly(sodium 4-styrenesulfonate) (PSS), acryloyl morpholine (ACMO), polyvinylpyrrolidone (PVP), and combinations thereof. According to a particular embodiment, the sacrificial layer comprises PSS.

The sacrificial layer may have a suitable thickness. For example, the thickness of the sacrificial layer may be 50-200 nm. In particular, the thickness of the sacrificial layer may be 50-200 nm, 75-175 nm, 100-150 nm, 125-140 nm, 130-135 nm. According to a particular embodiment, the thickness of the sacrificial layer may be 150 nm.

The sacrificial layer may be provided on the surface of the patterning substrate by any suitable method. For example, the sacrificial layer may be provided on the surface of the patterning substrate by, but not limited to, spin coating, aerosol spraying, doctor blading or dip coating, or a combination thereof. According to a particular embodiment, the sacrificial layer is provided by spin coating.

Once the sacrificial layer is provided on the surface of the patterning substrate, a thin film is provided on the sacrificial layer to form a patterning structure. Accordingly, step 104 comprises providing a thin film on the sacrificial layer. The thin film may be of any suitable material which may form a through-hole membrane. For example, the thin film may comprise a thermoplastic polymer. Any suitable thermoplastic polymer may be used for the purposes of the present invention. The thermoplastic polymer may be any suitable polymer which a low surface tension. Examples of the thermoplastic polymer include, but are not limited to: polystyrene (PS), poly(methyl methacrylate) (PMMA), polyether block amide, and combinations thereof. According to a particular embodiment, the thin film may comprise PS.

The thin film may have a suitable thickness. For example, the thin film may have a thickness of <1 μm. In particular, the thin film may have a thickness of 50-900 nm, 75-875 nm, 100-850 nm, 150-800 nm, 200-750 nm, 250-700 nm, 300-650 nm, 350-600 nm, 400-550 nm, 450-500 nm. According to a particular embodiment, the thickness of the thin film may be 100-500 nm.

The thin film may be provided on the sacrificial layer by any suitable method. For example, the thin film may be provided on the sacrificial layer by, but not limited to, spin coating, aerosol spraying, doctor blading or dip coating, or a combination thereof. According to a particular embodiment, the thin film is provided by spin coating.

The patterning substrate may be any suitable substrate. In particular, the patterning substrate may be any suitable substrate on which the sacrificial layer and thin film may be provided. The selection of the patterning substrate may differ depending on the sacrificial layer and the thin film to be provided on the surface of the patterning substrate. For example, the patterning substrate may comprise glass or silicon. In particular, a person skilled in the art would understand which substrate to use as a patterning substrate depending on the sacrificial layer and thin film to be provided. According to a particular embodiment, the patterning substrate comprises silicon.

FIG. 2(A) shows a patterning structure 112 according to a particular embodiment of the present invention. In particular, the patterning structure 112 comprises a patterning substrate 202, a sacrificial layer 204 and a thin film 206. The patterning substrate 202 may be the patterning substrate described above. The sacrificial layer 204 may be the sacrificial layer as described above. The thin film 206 may be the thin film as described above. In particular, the sacrificial layer 204 and the thin film 206 may be sequentially spin coated on a surface of the patterning substrate 202.

Step 106 comprises imprinting the thin film with a patterned mold to form a thin film through-hole membrane on the patterning structure. The patterned mold may have a pillar height which is more than the thickness of the thin film provided on the patterning structure.

The patterned mold may comprise any suitable polymer. The patterned mold may comprise any suitable polymer which is rigid enough to preserve the mechanical stability of small mold features while simultaneously being flexible enough to provide good conformal contact when contacted with the thin film. For example, the patterned mold may comprise an elastomeric polymer. The elastomeric polymer may be any suitable polymer which has a high surface energy. In particular, the elastometic polymer may be selected from the group consisting of, but not limited to: polydimethylsiloxane (PDMS), polyurethane acrylate (PUA), and combinations thereof. According to a particular embodiment, the elastomeric polymer may be PDMS. According to another particular embodiment, the elastomeric polymer may be PUA. In particular, a patterned mold comprising PUA is preferred for imprinting smaller pores. Even more in particular, a patterned mold comprising PUA is preferred for imprinting sub-500 nm sized pores on the thin film. An example of a thin film through-hole membrane formed using a patterned mold comprising PUA is shown in FIG. 3. The pore size of the formed thin film through-hole membrane is about 250 nm.

The patterned mold may have any suitable pattern and structure. For example, the patterned mold may be a cylindrical pillar structure, wherein each pillar has a diameter of about 0.55 μm.

The imprinting may be by any suitable method. For example, the imprinting may be by capillary force lithography (CFL). The imprinting may be carried out under suitable conditions. The suitable conditions may comprise a pre-determined temperature and pre-determined period of time. The pre-determined temperature may be any suitable temperature for the purposes of the present invention. According to a particular embodiment, the pre-determined temperature may be a temperature which is above the glass transition temperature of the thin film, but lower than the glass transition temperature of the sacrificial layer. In particular, the pre-determined temperature may be about 120-140° C.

In particular, the imprinting may comprise bringing the patterned mold to conformal contact with the thin film on the patterning structure followed by thermal annealing to facilitate membrane imprint by CFL. As shown in FIG. 2(B), a patterned mold 208 is brought into conformal contact with the thin film 206 of the patterning structure 112. The patterned mold 208 may be the patterned mold described above.

The use of the elastomeric patterned mold in CFL allows constant conformal contact between the patterned mold and the thin film, thereby ensuring uniform imprinting. Such uniform imprinting together with the thin film thickness being less than the pillar height of the patterned mold enables CFL patterning to span from the surface of the thin film which contacts the patterned mold to the surface of the thin film in contact with the sacrificial layer. In particular, capillary induced Laplace pressure drives the CFL, leading to spontaneous polymer melt filling into cavities along the contours of the confining patterned mold when thermal annealing is at a temperature above the glass transition temperature of the thin film. As a result of the CFL patterning during the imprinting, the imprint perforates the thin film to form a thin film through-hole membrane.

The pre-determined period of time (t) to form the thin film through-hole membrane during imprinting by capillary filling of the polymer of the thin film to a certain depth (z) is a factor of the capillary system and the polymer flow of the thin film. This is exemplified by Equation (1).

$$t = \frac{3 η}{R {γ}_{p} cos θ} [ \frac{1}{2} {Z}^{2} + \frac{{dR}^{2}}{3 η Pe} + \frac{2 {zR}^{2}}{{h}_{0} - z} - 2 ln ( \frac{{h}_{0}}{{h}_{0} - z} ) {R}^{2} ] \qquad ( 1 )$$

In particular, the capillary system comprises factors such as the size of the pattern of the patterned mold (R) and the air permeability of the patterned mold (d, Pe). The polymer flow of the thin film comprises factors such as thickness of the thin film (h₀), molecular weight, temperature, viscosity (η), and thin film-patterned mold wettability. Among these factors, the mold wettability is important as when the contact angle of the thin film melt on the surface of the patterned mold (θ) exceeds 90°, the capillary force for the CFL is negative and the liquid does not spontaneously fill through the capillary for patterning to occur on the thin film. This correlates with high polymer melt surface tension (γₚ) and/or low mold surface energy (γₘ). Accordingly, during the imprinting, the contact angle of the thin film polymer melt on the surface of the patterned mold may be a suitable angle. In particular, the contact angle may be <90°.

The thin film through-hole membrane formed from the imprinting comprises ordered and uniform-sized pores. The pores formed may have any suitable shape. For example, the pores may be spherical, oval, rod, and the like. The shape of the pores formed may be dependent on the conditions of the imprinting. For example, formation of oval shaped pores may be attributed to controlled dewetting of the thin film around the edges of cylindrical pillars of the patterned mold as the mold approaches the patterning substrate, thereby resulting in pore openings with distinct, noncircular morphology. If the thin film beneath the cylindrical pillars of the patterned mold are fully dewetted, the pores may be circular shaped. At elevated temperature and prolonged process time during the imprinting, the pillars of the patterned mold may collapse during the CFL, thereby forming rod shaped pores. Specific shapes of pores may be more suitable for certain applications. For example, elongated pores may be more suitable in lowering fouling tendency in filtration membranes. If spherical pores are desired at elevated temperatures and longer pre-determined period of time, the pillar deflection or collapse may be avoided by modifying the surface of the patterned mold.

Accordingly, the method 100 may optionally further comprise treating the patterned mold with plasma prior to the imprinting of step 106. The treating may be carried out under conditions suitable for the purposes of the present invention. The plasma exposure results in a thin silica-like surface layer having a high elastic modulus being formed on the surface of the patterned mold. The surface layer formed may impart higher mechanical stability and may minimise the pillar deflection during the imprinting at elevated temperatures and prolonged pre-determined period of time.

The treating of the patterned mold with plasma may also increase the surface energy of the patterned mold which enhances the capillary flow of the moderately hydrophilic polymer comprised in the patterned mold during CFL.

For the purposes of the present invention, the thin film through-hole membrane having an ordered array of pores refers to an array of pores having a systematic arrangement. For example, the pore array may be such that there are a pre-determined number of rows and columns of pores, each row and column having a pre-determined number of pores. The pores in each row and/or column may be the same or different. An ordered array of pores may also be taken to comprise pores arranged in a non-random manner. For example, each pore may be spaced equidistant from one another.

According to another particular aspect, the thin film through-hole membrane formed from the imprinting may comprise asymmetric pore channels. For the purposes of the present invention, asymmetric pore channels may be defined as channels which may be consist of a first shape on one side of the membrane and a second shape on the opposite side of the membrane. For example, the asymmetric channels may comprise spherical pore shape on the top side of the membrane and non-spherical pore shape on the bottom side, or spherical pores of different pore sizes on both sides of the membrane.

The pores may have any suitable size. The size of the pores formed may be dependent on the conditions of the imprinting. Pore size may be measured by (optical or electron) microscopy. Pore size of each pore refers to the average pore diameter. According to a particular aspect, the pores of the thin film through-hole membrane may have a substantially uniform pore size. For example, at least about 80% of the pores have a uniform pore size. In particular, at least about: 90%, 95%, 98% or 100% of the pores have a uniform pore size. The average size of each pore may be 0.08-0.4 μm. For example, the average size of each pore may be 0.1-0.35 μm, 0.15-0.3 μm, 0.2-0.25 μm.

FIG. 2(C) shows a structure 114 which comprises a thin film through-hole membrane 116 on a patterning substrate 202 according to a particular embodiment of the present invention. In particular, the through-holes extend all the way from the surface of layer 116 to the surface of the sacrificial layer 204 in contact with the substrate 202.

In order to release the thin film through-hole membrane, the method comprises a step 108 of contacting the patterning structure comprising the thin film through-hole membrane with water. The contacting may be under suitable conditions. For example, the contacting may be at room temperature. The water may also be at room temperature. During the contacting, the sacrificial layer may dissolve when contacted with water since the sacrificial layer comprises a water soluble polymer, thereby releasing the thin film through-hole membrane from the patterning structure. The released thin film through-hole membrane may be a free-standing thin film through-hole membrane.

The advantage of the sacrificial layer is that despite the thermal annealing during the imprinting of step 106 which enhances the adhesion between the membrane and the patterning substrate, providing the sacrificial layer which comprises a water soluble polymer enables the sacrificial layer to be dissolved when the patterning structure with the thin film through-hole membrane is contacted with water. In this way, the thin film through-hole membrane is released from the patterning structure and patterning substrate without requiring chemical etchants which may damage the integrity of the membrane. Further, the sacrificial layer provides a solvent resistant surface for direct formation of the thin film on the sacrificial layer by any suitable method, such as spin coating. The sacrificial layer is also thermally stable such that it is neither imprinted nor intermixed with the adjacent thin film during the imprinting of step 106.

The method 100 further comprises a step 110 of transferring the released thin film through-hole membrane onto a surface of a target substrate. The target substrate may be any suitable substrate. For example, the target substrate may be a substrate having a complex surface such as a patterned, flexible, non-planar, or curved surface. The method of the present invention enables a film to be easily provided on a target substrate comprising a complex surface. Depositing and patterning a thin film directly on a target substrate with a complex surface would otherwise be difficult using conventional processing steps. The target substrate may be a porous substrate. FIG. 2(D) shows a structure 118 which comprises a thin film through-hole membrane 116 on a target substrate 210 according to a particular embodiment of the present invention.

According to a particular embodiment, a method of forming the thin film through-hole membrane on a patterning substrate and subsequently transferring the thin film through-hole membrane to a target substrate is shown in FIG. 1(B). In particular, a patterning structure is provided at (i). The patterning structure comprises a PSS polysalt sacrificial layer provided on a surface of the patterning substrate and a polymer thin film layer provided on the PSS polysalt sacrificial layer. The PSS polysalt sacrificial layer and the polymer thin film layer may be provided on the patterning substrate by any suitable method, such as sequential spin coating. A PDMS patterned mold is then brought into conformal contact with the polymer thin film layer in (ii) to enable CFL patterning and imprinting of the polymer thin film layer. In particular, thermal annealing is carried out at a suitable temperature. For example, the temperature may be a temperature above the glass transition temperature of the polymer comprised in the polymer thin film layer. Once the polymer thin film layer is imprinted and is formed into a thin film through-hole membrane, the patterning structure is placed in water as shown in (iii). In water, the PSS polysalt sacrificial layer dissolves, thereby facilitating the detachment of the thin film through-hole membrane from the patterning substrate. The thin film through-hole membrane is then transferred to a target substrate of choice as shown in (iv) by contacting the thin film through-hole membrane with the surface of the target substrate. The surface of the target substrate may be pre-cleaned to be free from chemical and particulate contaminants.

The advantage of the method of the present invention is that none of the steps involves peeling or other deformation that may cause warping, stretching or bending of the thin film or the formed thin film through-hole membrane which would lead to the damage and fracture of the membrane. The method of the present invention therefore provides a reproducible and versatile method to form and subsequently transfer with high integrity and defect-free thin film through-hole membranes.

The method of the present invention may also be applied for repeated layering of thin film through-hole membranes on the target substrate by repeating the method for a number of times as required by the number of layers desired on the target substrate.

A second aspect of the present invention provides a thin film through-hole membrane prepared from the method described above. Examples of thin film through-hole membranes are shown in FIG. 1(C). In FIG. 1(C), (a) to (f) show optical microscopy images of thin film through-hole membranes with various pore sizes from 25 μm to <0.5 μm, while (g) to (i) show images of thin film through-hole membranes with pore sizes of 0.4 μm to 0.2 μm.

Membranes with nanoscale thickness are advantageous because fluid transport across the membrane scales inversely with membrane thickness. However, such membranes may not be robust enough without suitable mechanical support. Accordingly, the present invention provides a hierarchical membrane for graded filtration comprising at least one thin film through-hole membrane prepared according to the method 100. The hierarchical membrane may also comprise an underlying microporous mechanical support layer. Each of the thin film through-hole membrane and the microporous mechanical layer may have a suitable pore size, order, narrow size distribution and thickness. An example of a hierarchical membrane is shown in FIG. 4. As can be seen, there is provided a hierarchical membrane comprising three thin film through-hole membranes integrated in series. Each membrane comprises a different pore size. In particular, each membrane has a narrow pore size distribution of different range from the other two membranes. Such a hierarchical membrane enables optimised filtration efficiency.

According to one particular embodiment, the hierarchical membrane of the present invention may comprise a first thin film through-hole membrane prepared according to the method 100 and a second through-hole membrane with thickness and ordered pores in the micrometer range which may be used as a support layer for the thin film through-hole membrane. In particular, the first thin film through-hole membrane may be transferred onto the second through-hole membrane to form the hierarchical membrane.

The second membrane may be prepared by any suitable method. For example, the second membrane may be prepared by micro-molding in capillaries (MIMIC) using methods described in the art. For example, the first thin film through-hole membrane may comprise a thermoplastic polymer and the second membrane may comprise a ubiquitous ultraviolet (UV) curable resin. The thermoplastic polymer may be as described above. The UV curable resin may be any suitable UV curable resin such as, but not limited to, perfluoropolyether (PFPE), PUA, optical adhesives such as NOA, or a combination thereof.

According to one particular embodiment, the hierarchical membrane comprises at least two thin film through-hole membranes. The at least two thin film through-hole membranes may be prepared according to the method 100. Each of the thin film through-hole membranes comprised in the hierarchical membrane may comprise a different pore size.

The hierarchical membrane according to the present invention may be used in various applications. For example, the hierarchical membrane may be used in high selectivity filtration, stencil patterning, cell culture platforms, (bio)analytical and preparative microfluidic devices, and size and shape-selective membrane modules for product purification/fractionation and for environmental remediation (water and air).

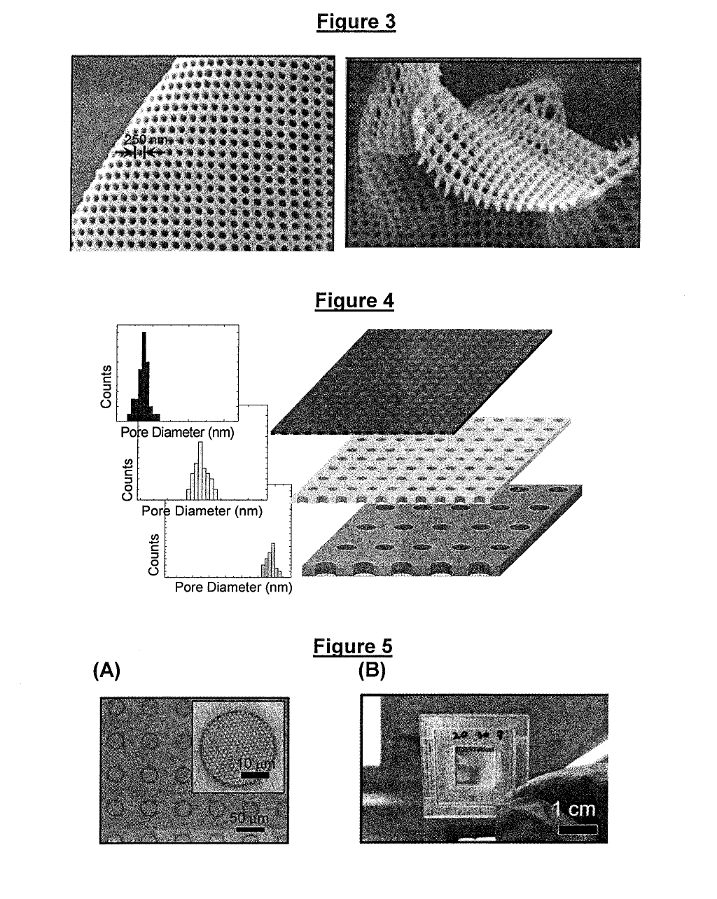

The hierarchical membrane may be comprised in a membrane module. An example is shown in FIG. 5B which comprises the hierarchical membrane shown in FIG. 5A. In particular, FIG. 5A shows the microscopy image of a hierarchical membrane comprising 25 μm and 0.35 μm membranes, while FIG. 5B shows a photograph of the hierarchical membrane as shown in FIG. 5A comprised in a membrane module.

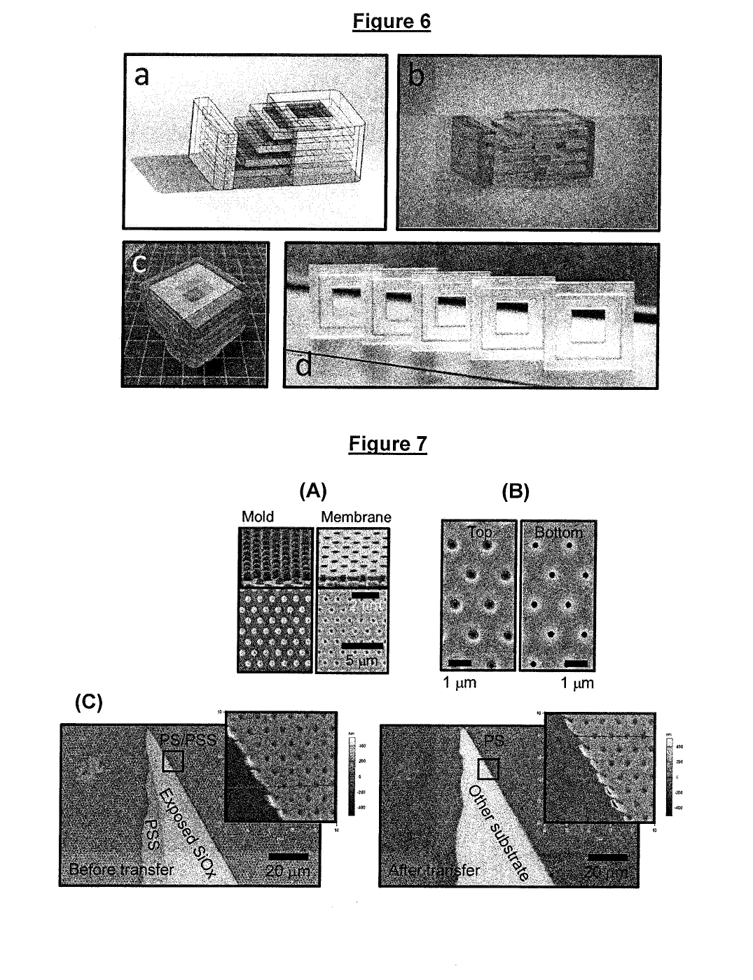

The membrane module may be combined with one or more membrane modules comprising hierarchical membranes of different pore sizes to form a membrane module housing. FIG. 6 shows a 3D-printed prototype of a membrane module housing, in which FIG. 6(d) shows individual membrane modules without a membrane. For example, for heavy duty filtration, individual membrane modules may be replaced on-demand for continuous filtration operation. In particular, the membrane module housing according to the present invention may be integrated into a portable air purifier or an air circulation system in an enclosed environment such as an aircraft cabin.

Whilst the foregoing description has described exemplary embodiments, it will be understood by those skilled in the technology concerned that many variations may be made without departing from the present invention.

Having now generally described the invention, the same will be more readily understood through reference to the following examples which are provided by way of illustration, and are not intended to be limiting.

### EXAMPLE

Materials

Thermoplastic polymers like polystyrene (PS) (BP Chemicals) was precipitated with excess methanol and vacuum dried before use. Poly(sodium 4-styrenesulfonate) (PSS) (Sigma-Aldrich) and ultraviolet (UV) light curable polymers like NOA73 (Norland Products Inc.) and perfluoropolyether (PFPE) based resin (MD-700, Solvay) and photoinitiator (2-Hydroxyl-2methylpropiophenone, Sigma-Aldrich) were used as received. Polyurethane acrylate (PUA) resin was formulated by mixing aliphatic urethane acrylate in tripropyleneglycol diacrylate (Ebecryl E265); trifunctional acrylate modulator: trimethylolpropane ethoxy triacrylate (TMPEOTA); photoinitiators Darocur 1173 and Irgacure 184. Polydimethylsiloxane (Sylgard 184, Dow Corning) working molds were replicated from photolithographically prepared silicon master molds having complementary relief structure.

### Example 1

Preparation of Thin Film Through-Hole Membranes

Capillary force lithography (CFL) was used to prepare the thin film through-hole membranes. Polymer solutions were prepared, stirred and filtered with 0.45 μm polytetrafluoroethylene (PTFE) syringe filters before use. First PSS, followed by polystyrene thin films were sequentially spin coated (3000 rpm, 30 s) onto cleaned glass or silicon substrates from PSS-deionised water (5 wt %) and polymer-toluene (2.5-6 wt %) solutions. The replicated patterned PDMS mold was then conformally placed onto the polymer-PSS bilayer for CFL above polymer's glass transition temperature. Selected PDMS molds were plasma treated in air (30 W, PDC-002, Harrick Plasma) and used immediately. Thin (≤1.5 mm-thick) PDMS mold minimised thermal stress build-up and ensured continual conformal contact during CFL at elevated temperature.

After PDMS demolding, the membrane-PSS bilayer sample edges were scored with blade before sliding it into DI water bath at a small angle. Upon contacting water, PSS sacrificial layer promotes interfacial water diffusion between membrane and substrate, the membrane thus separates from substrate and floats on the water bath surface for transfer. The transferred membranes were sandwiched between two pieces of aluminium sheets with pre-cut windows and sealed together with epoxy resin, before transferring onto custom module holder.

The method also allows the membrane to be inversely transferred, if required. Specifically, a flexible backing layer was placed onto the membrane top surface, a few drops of DI water was then dispensed at the edges which selectively diffuse into PSS sacrificial layer, facilitating membrane separation from the substrate and attachment to the backing layer, exposing the initially buried membrane bottom surface.

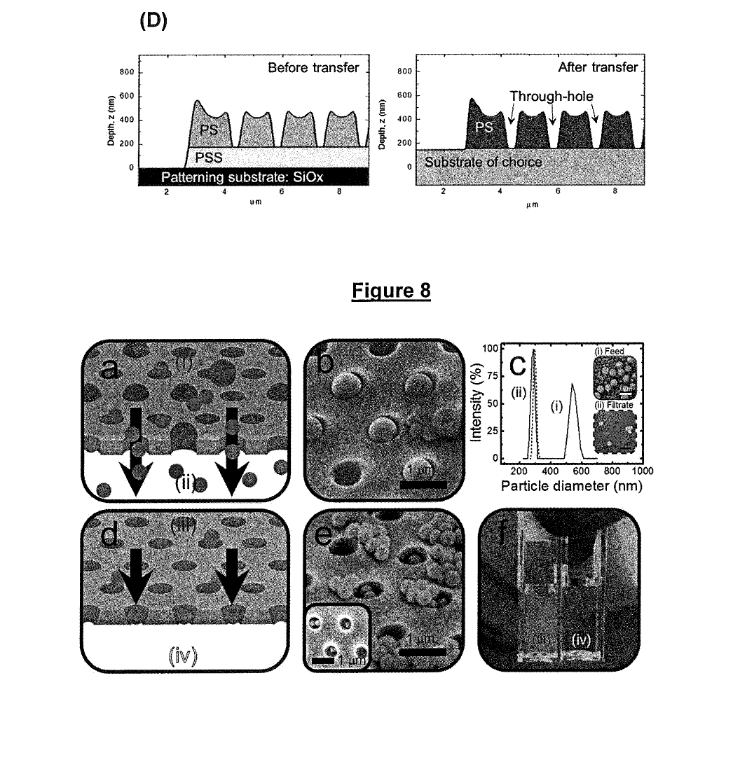

FIG. 7(A) shows Scanning Electron Microscopy (SEM) images of the PDMS pillar mold (left) and patterned polystyrene (PS) membrane (right), demonstrating that CFL can achieve good pattern uniformity.

In order to ascertain that the imprint spanned the entire polymer thin film thickness (h₀) i.e. membrane pores were open-through, membrane pore openings at both top and bottom surfaces were verified using SEM as shown in FIG. 7(B).

FIG. 7(C) shows the optical microscope images of a scratched membrane before and after membrane transfer. The planar Atomic Force Microscopy (AFM) images of the black square area in the optical micrographs are shown as insets and the membrane's cross-sectional profiles at locations indicated by the line cuts are shown in FIG. 7(D). It is observed that the membrane depth and topography are similar before and after transfer as shown in FIG. 7(D), demonstrating the clean removal of PSS sacrificial layer and good transfer fidelity of the method of the present invention. Owing to its high melting point (˜460° C.), the PSS layer does not get imprinted during the CFL patterning process, thus demonstrating the suitability of PSS in transferring films that are subjected to high temperature processing conditions.

### Example 2

Preparation of Hierarchical Membranes

A hierarchical membrane comprising a thin film through-hole membrane as prepared in Example 1 is placed on a support membrane. The support membrane had thickness and ordered pores in the micrometer range and was fabricated by another capillary and mold-based lithography method, namely micromolding in capillaries (MIMIC). In particular, the support membrane was prepared by UV curing of molded liquid prepolymer carried out using a 400 W metal halide flood light with λ=250-650 nm and 75 mW/cm² at 12 cm sample-to-light distance (UVR400/600, Epoxy & Equipment Technology).

### Example 3

The hierarchical membrane as prepared in Example 2 was tested for its high selectivity filtration.

The filtration experiments were carried out using a custom designed dead-end test cell. Polystyrene latex beads were purchased (Sigma-Aldrich) and reconstituted by adding filtered deionised water to form suspensions with different concentration. The filtration efficiency and particle size distribution were measured by analysing feed and filtrate streams using UV-visible spectrometer (USB4000, Ocean Optics) and DLS (NanoBrook Omni, Brookhaven Instruments), respectively. Scattering angle 90° was used for all DLS measurements. The solutions, especially the feed are diluted to prevent multiple scattering and viscosity effects for accurate particle size measurement.

Two liquid filtration experiments were designed to test and demonstrate the membrane's unique capabilities. Firstly, as a high selectivity size-exclusion-based sieve to discriminate species with small size difference (see schematic in FIG. 8a) and secondly, as a barrier to separate and capture single species (see schematic in FIG. 8d).

For the first filtration experiment, feed stream consists of binary latex particle mixtures of 0.3 μm and 0.6 μm suspended in DI water. The feed is filtered at pressure drop of 80-100 kPa with a hierarchical membrane having cut-off pore size (0.45 μm) between the size of both particle populations. SEM image of the membrane surface after filtration (FIG. 8b) shows the larger 0.3 μm particle fraction were filtered by the membrane, along with some trapped smaller (0.3 μm) particles. Particle size distribution analysis of the feed and filtrate streams using dynamic light scattering (DLS) and SEM (FIG. 8c) revealed that only the 0.3 μm particle fraction passed through the membrane, indicating its successful separation from the mixture.

In the second filtration experiment, the feed stream comprised only 0.3 μm particles. Filtration was performed with membrane having asymmetric pore size at top (˜0.4 μm) and bottom (˜0.25 μm) surface. The photograph in FIG. 8f compares the turbid feed solution on the left and the relatively clear filtrate solution on the right which had ˜88±3% of particles separated, as determined from the UV-vis absorption spectra of both feed and filtrate. As the geometry of the membrane pores (depth and lateral size and shape) may be tuned to closely match those of the particles, the membrane possesses the unique ability to capture particle or particles with certain arrangements within its pores. While some 0.3 μm particles were collected on the membrane surface, many were also encapsulated either individually or as duplet clusters within the pore channels with asymmetric top and bottom openings (see FIG. 8e). An unfilled pore is shown in the inset of FIG. 8e. Such membrane may be useful in applications such as sterile filtration, environmental remediation and product fractionation, by sorting and capturing (or releasing) cargo of interest such as microorganisms, white blood cells, and nanoparticles for downstream sensing, analysis and diagnostic.

As each membrane has well controlled pore size and high size selectivity, having the membranes working in tandem can yield higher combined filtration performance. To do that, a proof-of-concept multi-membrane filtration cell was designed. The 3D-printed filtration cell has multiple slots for the membrane modules (see FIGS. 5(B) and 6) to be placed in series for multiple filtration operations. At high feed particle concentrations however, membrane fouling was observed particularly for small particle size. The filtration cell and membrane modular design may facilitate on-demand membrane replacement for continuous filtration operation and/or for product retrieval and analysis.

### Example 4

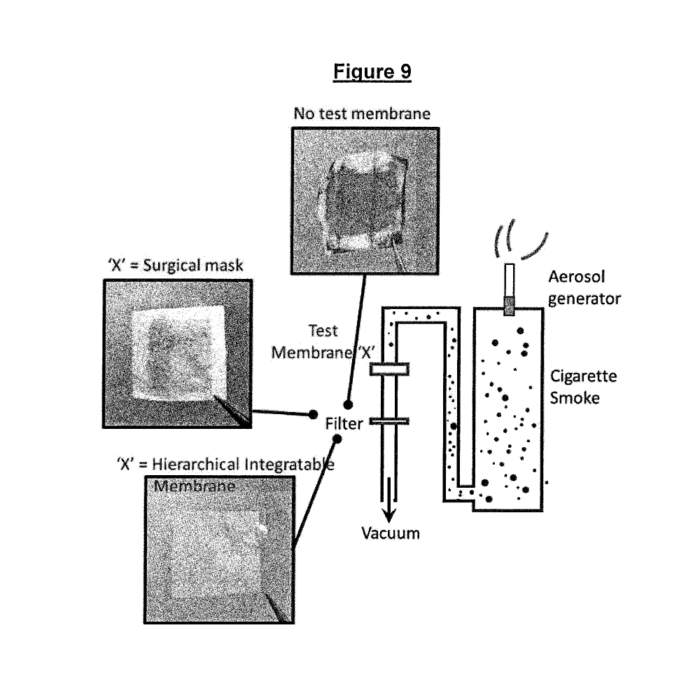

The filtration performance of the hierarchical membrane was evaluated with an experimental setup that generates polydisperse smoke aerosol as shown in FIG. 9. In particular, a pump drew air through a single cigarette to the test membrane, followed by an end filter made of electrospun micro-fibres to capture the aerosol transmitted from the test membrane.

Thick tobacco residue was captured by the filter when the test membrane was absent. Between a fibre-based surgical mask and the hierarchical membrane, considerably less tar was transmitted through the membrane module comprising the hierarchical membrane comprising stacked 20 μm and 0.35 μm grade membranes as seen in FIG. 9.

1. A method of forming a thin film through-hole membrane comprising:
(a) providing a patterning structure, wherein the patterning structure comprises a patterning substrate, a sacrificial layer provided on a surface of the patterning substrate and a thin film provided on the sacrificial layer, the sacrificial layer comprising a water-soluble polymer;
(b) imprinting the thin film with a patterned mold at a pre-determined temperature for a pre-determined period of time to form the thin film through-hole membrane; and
(c) contacting the patterning structure with water to dissolve the sacrificial layer, thereby releasing the thin film through-hole membrane from the patterning structure.

2. The method of claim 1, wherein the method further comprises transferring the released thin film through-hole membrane onto a surface of a target substrate.

3. The method of claim 1, wherein
the thin film comprises a thermoplastic polymer.

4. The method of claim 3, wherein the thermoplastic polymer is selected from the group consisting of polystyrene (PS), poly(methyl methacrylate) (PMMA), polyether block amide, and combinations thereof.

5. The method of claim 1, wherein the water-soluble polymer is selected from the group consisting of poly(sodium 4-styrenesulfonate) (PSS), acryloyl morpholine (ACMO), polyvinylpyrrolidone (PVP), and combinations thereof.

6. (canceled)

7. The method of claim 1, wherein the thin film has a thickness which is less than pillar height of the patterned mold.

8. The method of claim 1 wherein the thin film has a thickness of <1 μm.

9. The method of claim 1, wherein the sacrificial layer has a thickness of 50-200 nm.

10. The method of claim 1, wherein the imprinting is by capillary force lithography (CFL).

11. The method of claim 1, wherein the patterned mold comprises an elastomeric polymer.

12. The method of claim 11, wherein the patterned mold comprises an elastomeric polymer selected from the group consisting of polydimethylsiloxane (PDMS), polyurethane acrylate (PUA), and combinations thereof.

13. The method of claim 1, wherein the pre-determined temperature is a temperature above the glass transition temperature of the thin film.

14. The method of claim 1, wherein the pre-determined temperature is a temperature lower than the glass transition temperature of the water-soluble polymer comprised in the sacrificial layer.

15. The method of claim 1, wherein contact angle of the thin film polymer melt on a surface of the patterned mold contacting the thin film is <90°.

16. The method of claim 1, wherein the contacting comprises contacting the patterning structure with water at room temperature.

17. The method of claim 1, wherein the thin film through-hole membrane comprises ordered and uniform-sized pores.

18. The method of claim 1, wherein the method further comprises treating the patterned mold with plasma prior to the imprinting.

19. A thin film through-hole membrane prepared from the method of claim 1.

20. A hierarchical membrane for graded filtration comprising at least one thin film through-hole membrane of claim 19, wherein each thin film through-hole membrane comprises a different pore size.

21. The hierarchical membrane of claim 20, wherein the hierarchical membrane is comprised in a membrane module housing.
